(19) United States
(12) Patent Application Publication
(10) Pub. No.: US 2015/0287376 A1
(43) Pub. Date: Oct. 8, 2015

(54) GATE DRIVER AND DISPLAY DEVICE INCLUDING THE SAME

(71) Applicant: Samsung Display Co., Ltd., Yongin-City (KR)

(72) Inventors: Jae Keun LIM, Suwon-si (KR); Cheol Gon LEE, Seoul (KR); Chong Chul CHAI, Seoul (KR)

(21) Appl. No.: 14/567,963

(22) Filed: Dec. 11, 2014

(30) Foreign Application Priority Data
Apr. 4, 2014 (KR) 10-2014-0040578

(51) Int. Cl. G09G 3/36

(52) U.S. Cl. CPC G09G 3/3648; G09G 2330/023; G09G 2300/0809

(57) ABSTRACT

A gate driver and a display device are disclosed. In one aspect, the gate driver includes a plurality of stages connected in cascade. Each of the stages includes an input unit, an output unit and a carry signal generator. The input unit connects a first input terminal and a first node and includes a first input transistor and a second input transistor. The output unit connects the first node and a first output terminal and includes an output transistor and an output capacitor. The carry signal generator connects a clock terminal and a second output terminal. An output terminal of the first input transistor and an input terminal of the second input terminal are connected to a second node. The input unit further includes a diode-connected transistor applying a carry signal from the first output terminal to the second node.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

This application claims priority to Korean Patent Application No. 10-2014-0040578 filed on Apr. 4, 2014 in the Korean Intellectual Property Office, the disclosure of which is incorporated herein by reference in its entirety.

### BACKGROUND

1. Field

The described technology generally relates to a display device, and more particularly, to a display device including a gate driver.

2. Description of the Related Technology

A display device includes a plurality of pixels, which are arranged in a matrix, and realizes a color and a grayscale level according to a data signal applied to the pixels. The display device includes a data driver generating a data signal to be applied to the pixels. The data driver generates a data signal corresponding to an image to be displayed by the display device.

Each of the pixels can decide whether to receive a data signal based on a gate signal. The display device can also include a gate driver generating a gate signal. The gate driver can include a plurality of shift registers. The shift registers can be sequentially driven to generate a gate-on signal that enables the pixels to receive a data signal.

### SUMMARY OF CERTAIN INVENTIVE ASPECTS

One inventive aspect is a gate driver capable of preventing the deterioration of transistors.

Another aspect is a display device including a gate driver capable of preventing the deterioration of transistors.

Another aspect is a gate driver comprising a plurality of stages configured to be connected in cascade, wherein each of the stages includes an input unit connecting a first input terminal and a first node and including a first input transistor and a second input transistor, an output unit connecting the first node and a first output terminal and including an output transistor and an output capacitor, and a carry signal generation unit connecting a clock terminal and a second output terminal, wherein an output terminal of the first input transistor and an input terminal of the second input terminal are connected to a second node and the input unit further includes a diode-connected transistor applying a carry signal from the first output terminal to the second node.

A previous-stage carry signal may be applied to the first input terminal and a current-stage carry signal is output from the first output terminal.

Control terminals of the first input transistor and the second input transistor may be connected to the first input terminal.

Each of the stages may further include an inverter unit connecting the clock terminal and a third node and including at least two transistors, a noise removal unit connecting a first power terminal and the second output terminal and including at least one transistor, and a pull-down unit applying a voltage at a second power terminal to the first output terminal or the second output terminal according to a signal applied to the second input terminal.

A clock signal may be applied to the clock terminal, a subsequent-stage carry signal is applied to the second input terminal, a current-stage gate signal is output from the second output terminal, a first gate-off signal is applied to the first power terminal and a second gate-off signal is applied to the second power terminal.

The noise removal unit may connect the second power terminal and the first node and includes at least one transistor.

The inverter unit may include a third output terminal connected to the third node and outputting an inverter output signal.

Another aspect is a gate driver comprising a plurality of stages configured to be connected in cascade, wherein each of the stages includes an input unit connecting a first input terminal and a first node and including a first input transistor and a second input transistor, an output unit connecting the first node and a second output terminal and including an output transistor and an output capacitor, and a carry signal generation unit connecting a clock terminal and a first output terminal, wherein an output terminal of the first input transistor and an input terminal of the second input terminal are connected to a second node and the input unit further includes a diode-connected transistor applying a carry signal from the second output terminal to the second node.

A previous-stage carry signal may be applied to the first input terminal, a current-stage carry signal is output from the first output terminal, and a current-stage gate signal is output from the second output terminal.

Control terminals of the first input transistor and the second input transistor may be connected to the first input terminal.

Each of the stages may further include an inverter unit connecting the clock terminal and a third node and including at least two transistors, a noise removal unit connecting a first power terminal and the second output terminal and including at least one transistor, and a pull-down unit applying a voltage at a second power terminal to the first output terminal or the second output terminal according to a signal applied to the second input terminal, and the carry signal generation unit includes at least one transistor.

A clock signal may be applied to the clock terminal, a subsequent-stage carry signal is applied to the second input terminal, a first gate-off signal is applied to the first power terminal and a second gate-off signal is applied to the second power terminal.

The noise removal unit may connect the second power terminal and the first node and includes at least one transistor.

The inverter unit may include a third output terminal connected to the third node and outputting an inverter output signal.

Another aspect is a display device, comprising a display panel, and a gate driver configured to provide a gate signal to the display panel, and comprising a plurality of stages connected in cascade, wherein each of the stages includes an input unit connecting a first input terminal and a first node and including a first input transistor and a second input transistor, an output unit connecting the first node and a second output terminal and including an output transistor and an output capacitor, and a carry signal generation unit connecting a clock terminal and a first output terminal, wherein an output terminal of the first input transistor and an input terminal of the second input terminal are connected to a second node and the input unit further includes a diode-connected transistor applying a carry signal from the second output terminal to the second node.

A previous-stage carry signal may be applied to the first input terminal, a current-stage carry signal is output from the first output terminal, and control terminals of the first input transistor and the second input transistor are connected to the first input terminal.

Each of the stages may further includes an inverter unit connecting the clock terminal and a third node and including at least two transistors, a noise removal unit connecting a first power terminal and the second output terminal and including at least one transistor, and a pull-down unit applying a voltage at a second power terminal to the first output terminal or the second output terminal according to a signal applied to the second input terminal, and the carry signal generation unit includes at least one transistor.

A clock signal may be applied to the clock terminal, a subsequent-stage carry signal may be applied to the second input terminal, a current-stage gate signal may be output from the second output terminal, a first gate-off signal may be applied to the first power terminal and a second gate-off signal may be applied to the second power terminal.

The noise removal unit may connect the second power terminal and the first node and may include at least one transistor.

The inverter unit may include a third output terminal connected to the third node and outputting an inverter output signal. Another aspect is a gate driver for a display device, comprising: a plurality of stages connected in cascade, wherein each of the stages includes: an input unit configured to connect a first input terminal and a first node, wherein the input unit includes first and second input transistors; an output unit configured to connect the first node and a first output terminal, wherein the output unit includes an output transistor and an output capacitor; and a carry signal generator configured to connect a clock terminal and a second output terminal, wherein an output terminal of the first input transistor and an input terminal of the second input terminal are connected to a second node and wherein the input unit further includes a diode-connected transistor configured to apply a carry signal from the first output terminal to the second node.

In the above gate driver, the first input terminal is configured to receive a previous-stage carry signal and wherein the first output terminal is configured to output a current-stage carry signal. In the above gate driver, control terminals of the first input transistor and the second input transistor are connected to the first input terminal. In the above gate driver, each of the stages further includes: an inverter configured to connect the clock terminal and a third node, wherein the inverter includes at least two transistors; a noise remover configured to connect a first power terminal and the second output terminal, wherein the noise remover includes at least one transistor; and a pull-down unit configured to apply a voltage at a second power terminal to the first output terminal or the second output terminal according to a signal applied to the second input terminal.

In the above gate driver, the clock terminal is configured to receive a clock signal, wherein the second input terminal is configured to receive a subsequent-stage carry signal, wherein the second output terminal is configured to output a current-stage gate signal, wherein the first power terminal is configured to receive a first gate-off signal and wherein the second power terminal is configured to receive a second gate-off signal. In the above gate driver, the noise remover is further configured to connect the second power terminal and the first node and includes at least one transistor. In the above gate driver, the inverter includes a third output terminal connected to the third node and is configured to output an inverter output signal.

Another aspect is a gate driver for a display device, comprising: a plurality of stages connected in cascade, wherein each of the stages includes: an input unit configured to connect a first input terminal and a first node, wherein the input unit includes first and second input transistors; an output unit configured to connect the first node and a second output terminal, wherein the output unit includes an output transistor and an output capacitor; and a carry signal generator configured to connect a clock terminal and a first output terminal, wherein an output terminal of the first input transistor and an input terminal of the second input terminal are connected to a second node and wherein the input unit further includes a diode-connected transistor configured to apply a carry signal from the second output terminal to the second node.

In the above gate driver, the first input terminal is configured to receive a previous-stage carry signal, wherein the first output terminal is configured to receive a current-stage carry signal, and the second input terminal is configured to output a current-stage gate signal. In the above gate driver, control terminals of the first input transistor and the second input transistor are connected to the first input terminal. In the above gate driver, each of the stages further includes: an inverter configured to connect the clock terminal and a third node, wherein the inverter includes at least two transistors; a noise remover configured to connect a first power terminal and the second output terminal, wherein the noise remover includes at least one transistor; and a pull-down unit configured to apply a voltage at a second power terminal to the first output terminal or the second output terminal according to a signal applied to the second input terminal, and wherein the carry signal generator includes at least one transistor.

In the above gate driver, the clock terminal is configured to receive a clock signal, wherein the second input terminal is configured to receive a subsequent-stage carry signal, wherein the first power terminal is configured to receive a first gate-off signal and wherein the second power terminal is configured to receive a second gate-off signal. In the above gate driver, the noise remover is further configured to connect the second power terminal and the first node and includes at least one transistor. In the above gate driver, the inverter includes a third output terminal connected to the third node and is configured to output an inverter output signal.

Another aspect is a display device, comprising: a display panel; and a gate driver configured to provide a gate signal to the display panel, and comprising a plurality of stages connected in cascade, wherein each of the stages includes: an input unit configured to connect a first input terminal and a first node, wherein the input unit includes first and second input transistors; an output unit configured to connect the first node and a second output terminal, wherein the output unit includes an output transistor and an output capacitor; and a carry signal generator configured to connect a clock terminal and a first output terminal, wherein an output terminal of the first input transistor and an input terminal of the second input terminal are connected to a second node and wherein the input unit further includes a diode-connected transistor configured to apply a carry signal from the second output terminal to the second node.

In the above display device, the first input terminal is configured to receive a previous-stage carry signal, wherein the first output terminal is configured to receive a current-stage carry signal, and wherein control terminals of the first input transistor and the second input transistor are connected to the first input terminal. In the above display device, each of the stages further includes: an inverter configured to connect the clock terminal and a third node, wherein the inverter includes at least two transistors; a noise remover configured to connect a first power terminal and the second output terminal, wherein the noise remover includes at least one transistor; and a pull-down unit configured to apply a voltage at a second power terminal to the first output terminal or the second output terminal according to a signal applied to the second input terminal, and wherein the carry signal generator includes at least one transistor.

In the above display device, the clock terminal is configured to receive a clock signal, wherein the second input terminal is configured to receive a subsequent-stage carry signal, wherein the second output terminal is configured to receive a current-stage gate signal, wherein the first power terminal is configured to receive a first gate-off signal and wherein the second power terminal is configured to receive a second gate-off signal. In the above display device, the noise remover is further configured to connect the second power terminal and the first node and includes at least one transistor. In the above display device, the inverter includes a third output terminal connected to the third node and outputting an inverter output signal.

According to at least one of the exemplary embodiments, a liquid crystal display (“LCD”) is capable of improving the reliability of a gate driver.

Also, an LCD is capable of reducing the power consumption of a gate driver.

### BRIEF DESCRIPTION OF THE DRAWINGS

FIG. 1 is a block diagram of a display device according to an exemplary embodiment.

FIG. 2 is a circuit diagram of an exemplary embodiment of a pixel illustrated in FIG. 1.

FIG. 3 is a block diagram of a gate driver according to an exemplary embodiment.

FIG. 4 is a circuit diagram of a j-th stage of the gate driver illustrated in FIG. 3.

FIG. 5 is a voltage-current graph of a transistor Tr4-1 illustrated in FIG. 4.

FIG. 6 is a timing diagram illustrating the operating characteristics of a gate driver using an oxide semiconductor.

FIG. 7 is a timing diagram illustrating the operating characteristics of the gate driver illustrated in FIG. 3.

FIGS. 8 to 11 are circuit diagrams of j-th stages of gate drivers according to other exemplary embodiments.

FIG. 12 is a block diagram of a gate driver according to another exemplary embodiment.

FIG. 13 is a circuit diagram of a j-th stage of the gate driver illustrated in FIG. 12.

FIG. 14 is a circuit diagram of a j-th stage of a gate driver according to another exemplary embodiment.

FIG. 15 is a timing diagram illustrating the operating characteristics of the gate driver illustrated in FIG. 14.

FIGS. 16 to 20 are circuit diagrams of j-th stages of gate drivers according to other exemplary embodiments.

### DETAILED DESCRIPTION OF CERTAIN INVENTIVE EMBODIMENTS

Each of the shift registers typically includes a plurality of transistors. The properties of the transistors vary in accordance with a variation in the surrounding environment. For example, the higher the voltage applied between the drain and the source of each of the transistors, the more likely the transistors degrade. However, this may result in a decrease in the level of an input signal, finally leading to a decrease in the level of the output signal of the transistors. As a result, the display device may not be able to display a desired image.

Advantages and features of the described technology can be understood more readily by reference to the following detailed description of embodiments and the accompanying drawings. Like numbers refer to like elements throughout. In the drawings, the thickness of layers and regions are exaggerated for clarity.

It will be understood that when an element or layer is referred to as being “on,” or “connected to” another element or layer, it can be directly on or connected to the other element or layer or intervening elements or layers may be present. In contrast, when an element is referred to as being “directly on” or “directly connected to” another element or layer, there are no intervening elements or layers present. As used herein, the term “and/or” includes any and all combinations of one or more of the associated listed items.

Spatially relative terms, such as “below,” “beneath,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. In this disclosure, the term “substantially” includes the meanings of completely, almost completely or to any significant degree under some applications and in accordance with those skilled in the art.

Embodiments described herein will be described referring to plan views and/or cross-sectional views by way of ideal schematic views of embodiments. Accordingly, the exemplary views may be modified depending on manufacturing technologies and/or tolerances. Therefore, the disclosed embodiments are not limited to those shown in the views, but include modifications in configuration formed on the basis of manufacturing processes. Therefore, regions exemplified in figures have schematic properties and shapes of regions shown in figures exemplify specific shapes of regions of elements and not limit aspects of the described technology.

Hereinafter, embodiments will be described with reference to the attached drawings.

A display device according to an exemplary embodiment will hereinafter be described. In the description that follows, it is assumed that the display device is a liquid crystal display (“LCD”). However, the described technology can be applied to various types of display devices, other than an LCD.

Exemplary embodiments will hereinafter be described with reference to the accompanying drawings.

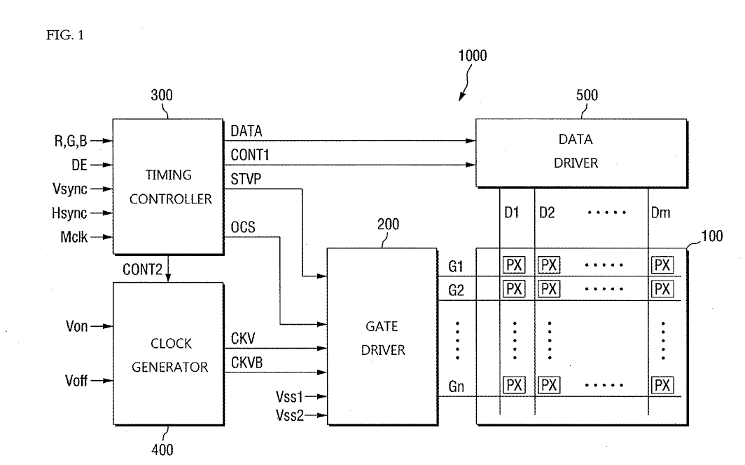

FIG. 1 is a block diagram of a display device according to an exemplary embodiment.

Referring to FIG. 1, a display device 1000 includes a display panel 100 and a gate driver 200.

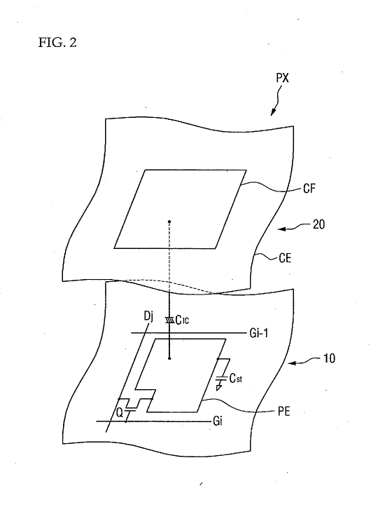

The display panel 100 includes a plurality of gate lines G1, G2, . . . , Gn, a plurality of data lines D1, D2, . . . , Dm, and a plurality of pixels PX, which are formed at the intersections between the gate lines G1, G2, . . . , Gn and the data lines D1, D2, . . . , Dm. The pixels PX may realize a grayscale level corresponding to a data signal applied to the data lines D1, D2, . . . , Dm, and the gate lines G1, G2, . . . , Gn may decide whether to receive the data signal according to a gate signal applied to the gate lines G1, G2, . . . , Gn. The pixels PX will hereinafter be described with reference to FIG. 2.

FIG. 2 is a circuit diagram of an exemplary embodiment of a pixel illustrated in FIG. 1. More specifically, FIG. 2 illustrates a circuit diagram of a pixel PX of the display panel 100, assuming that the display panel 100 is a liquid crystal panel. However, the display panel 100 can be an organic light-emitting diode (OLED) display panel, a plasma display panel, a field emission display (“FED”) panel, an electrophoretic display panel, etc.

Referring to FIG. 2, a color filter CF may be formed on part of a common electrode CE on a second substrate 20, and may correspond to a pixel electrode PE on a first substrate 10. The pixel PX, which is connected to, for example, an i-th gate line Gi (where i=1˜n) and a j-th data line Dj (where j=1˜m), may include a switching device Q, which is connected to the i-th gate line Gi and the j-th data line Dj, and a liquid crystal capacitor Clc and a storage capacitor Cst, which are connected to the switching device Q. The storage capacitor Cst may be optional. The switching device Q may be, for example, an amorphous silicon (“a-Si”) thin-film transistor (“TFT”). The color filter CF is illustrated in FIG. 2 as being formed on the second substrate 20 having the common electrode CE. The color filter CF may be formed on the first substrate 100.

The switching device Q may be a TFT. The gate of the switching device Q may be connected to the i-th gate line Gi, the source of the switching device Q may be connected to the j-th data line Dj, and the drain of the switching device Q may be connected to first ends of the liquid crystal capacitor Clc and the storage capacitor Cst. The switching device Q may decide whether to transmit a data signal applied to the j-th data line Dj to the first ends of the liquid crystal capacitor Clc and the storage capacitor Cst according to a gate signal applied to the i-th gate line Gi.

The liquid crystal capacitor Clc may be a virtual capacitor corresponding to the capacitance of a liquid crystal layer between the pixel electrode PE, to which a data signal is applied, and the common electrode CE, to which a common voltage Vcom is applied. The optical transmittance of the liquid crystal layer may be controlled by a potential difference between both ends of the liquid crystal capacitor Clc. The first end of the liquid crystal capacitor Clc may be connected to the drain of the switching device Q, and the common voltage Vcom may be applied to the second end of the liquid crystal capacitor Clc.

The first end of the storage capacitor Cst may be connected to the drain of the switching device Q, and the common voltage Vcom may be applied to a second end of the storage capacitor Cst. That is, the storage capacitor Cst may be arranged in parallel to the liquid crystal capacitor Clc. The storage capacitor Cst may increase the capacitance between the pixel electrode PE and the common electrode CE, and may thus effectively maintain the voltage applied to both ends of the liquid crystal capacitor Clc even when the switching device Q is turned off. In an exemplary embodiment, the storage capacitor Cst may not be provided in the pixel PX.

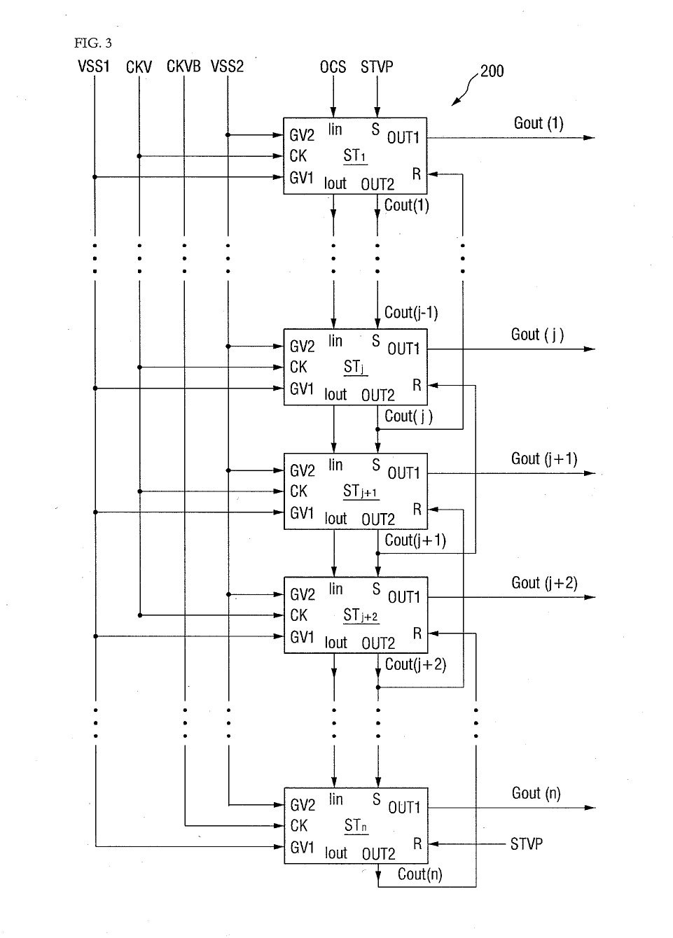

Referring back to FIG. 1, the gate driver 200 may provide a gate signal to each of the gate lines G1, G2, . . . , Gn by using a start pulse signal STVP, an output control signal OCS, a clock signal CKV, an inverted clock signal CKVB, a first gate-off voltage VSS1 and a second gate-off voltage VSS2. The gate driver 200 will be described later in further detail with reference to FIG. 3.

The display device 1000 also includes a timing controller 300, a data driver 500 and a clock generator 400.

The timing controller 300 may receive an input image signal (R, G, B) and an input control signal for controlling the display of the input image signal, may generate an image data signal DATA and a data driver control signal CONT1, and may provide the image data signal DATA and the data driver control signal CONT1 to the data driver 500. The timing controller 300 may receive input control signals such as a horizontal synchronization signal Hsync and a vertical synchronization signal Vsync, a main clock signal Mclk, and a data enable signal DE, and may output the data driver control signal CONT1. The data driver control signal CONT1, which is a signal for controlling the operation of the data driver 500, may include a horizontal start signal initiating the operation of the data driver 500 and a load signal giving instructions to output a data voltage. The timing controller 300 may provide a clock generation control signal CONT2 to the clock generator 400. The clock generation control signal CONT2 may include a gate clock signal determining when to output a gate-on voltage Von, and an output enable signal determining the pulse width of the gate-on voltage Von. The timing controller 300 may provide the start pulse signal STVP and the output control signal OCS to the gate driver 200.

The data driver 500 may receive the image data signal DATA and the data driver control signal CONT1, and may provide a data signal corresponding to the image data signal DATA to the data lines D1 through Dm.

The clock generator 400 may generate the clock signal CKV and the inverted clock signal CKVB according to the clock generation control signal CONT2. The inverted clock signal CKVB may be an inverted signal or a half-cycle-delayed signal of the clock signal CKV.

The gate driver 200 will hereinafter be described with reference to FIG. 3.

FIG. 3 is a block diagram of a gate driver according to an exemplary embodiment.

Referring to FIG. 3, the gate driver 200 includes a plurality of first through n-th stages ST₁ through STₙ which are connected in cascade to one another. Each of the first through n-th stages ST₁ through STₙ includes a first power terminal GV1, a second power terminal GV2, a clock terminal CK, an inverter input terminal Iin, an inverter output terminal Iout, a gate voltage output terminal OUT1, a carry signal output terminal OUT2, a first input terminal R, and a second input terminal S.

The second input terminal S of a j-th stage STⱼ (where j≠1), which is connected to a j-th gate line Gj, may receive a carry signal Cout(j−1) from a previous stage, i.e., a (j−1)-th stage ST₍ⱼ₋₁₎. The first input terminal R of the j-th stage STⱼ may receive a carry signal Cout(j+1) from a subsequent stage, i.e., a (j+1)-th stage ST₍ⱼ₊₁₎ and the clock terminal CK of the j-th stage STⱼ may receive the clock signal CKV and the inverted clock signal CKVB. The first power terminal GV1 of the j-th stage STⱼ may receive the first gate-off voltage VSS1 and the second power terminal GV2 of the j-th stage STⱼ may receive the second gate-off voltage VSS2. The inverter input terminal Iin of the j-th stage STⱼ may receive a voltage provided by a third node Inode of an inverter unit 212 of the (j−1)-th stage STⱼ or the output control signal OCS. The gate voltage output terminal OUT1 of the j-th stage STⱼ may output a gate signal Gout(j). The carry signal output terminal OUT2 of the j-th stage STⱼ may output a carry signal Cout(j). The inverter output terminal Iout of the j-th stage STⱼ may output a voltage provided by a third node of an inverter unit or inverter 212 of the j-th stage STⱼ.

The first stage ST₁ may receive the start pulse signal STVP, instead of a carry signal from a previous stage thereof, and the n-th stage STₙ, which is the last stage of the gate driver 200, may receive the start pulse signal STVP, instead of a carry signal from a subsequent stage thereof.

The clock terminals CK of the first through n-th stages ST1 through STn may receive the clock signal CKV and the inverted clock signal CKVB, which are generated by the clock generator 400. The gate voltage output terminals OUT1 of the first through n-th stages ST1 through STn may output a high-level portion of the clock signal CKV, which is applied to the clock terminals CK of the first through n-th stages ST1 through STn. The clock signal CKV may be applied to the odd-numbered stages ST, ST3, . . . , and the high-level portion of the clock signal CKV may be output from the gate voltage output terminals OUT1 of the odd-numbered stages ST, ST3, . . . . The clock signal CKV is applied to the even-numbered stages ST2, ST4, . . . , and a high-level portion of the inverted clock signal CKVB is output from the gate voltage output terminals OUT1 of the even-numbered stages ST2, ST4,

Accordingly, the first through n-th stages ST₁ through STₙ may sequentially output first through n-th gate signals Gout(1) through Gout(n), respectively.

Each of the first through n-th gate signals Gout(1) through Gout(n), which are respectively output from the gate voltage output terminals OUT1 of the first through n-th stages ST₁ through STₙ, may be applied to the first through n-th gate lines G1 through Gn, respectively.

The first power terminals GV1 of the first through n-th stages ST₁ through STₙ may be connected to a source of the first gate-off voltage VSS1, and the second power terminals GV2 of the first through n-th stages ST₁ through STₙ may be connected to a source of the second gate-off voltage VSS2.

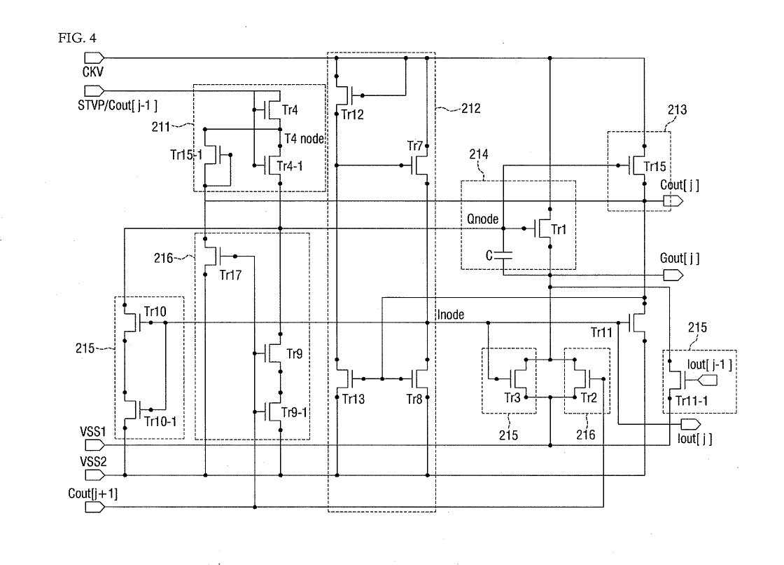

The first through n-th stages ST1 through STn of the gate driver 200 will hereinafter be described in further detail with reference to FIGS. 4 through 7

FIG. 4 is a circuit diagram of a j-th stage of the gate driver illustrated in FIG. 3. Referring to FIG. 4, the j-th stage STj of the gate driver 200, which is connected in cascade to other stages of the gate driver 200, may include an input unit 211, an inverter unit 212, a carry signal generation unit or carry signal generator 213, an output unit 214, a noise removal unit or noise remover 215 and a pull-down unit 216. The input unit 211 connects a first input terminal R and a first node Qnode. The carry signal generation unit 213 connects a clock terminal CK and a second output terminal OUT2. The output unit 214 connects the first node Qnode and a gate voltage output terminal OUT1 and includes a transistor Tr1 and an output capacitor C.

The input unit 211 may include the transistor Tr4, the transistor Tr4-1 and a transistor Tr15-1. The transistors Tr4 and Tr4-1 are a pair of transistors with their control terminals connected in common to the first input terminal R. The output terminal of the transistor Tr4 and the input terminal of the transistor Tr4-1 are connected to a second node T4node. The input terminal of the transistor Tr4 is connected to the first input terminal R, and the output terminal of the transistor Tr4-1 is connected to the first node Qnode. The second node T4node to which the transistors Tr4 and Tr4-1 are both connected may include a transistor Tr15. The input terminal and the control terminal of the transistor Tr15-1 may be connected in common (i.e., diode-connected) to the carry signal output terminal OUT2, and the output terminal of the transistor Tr15-1 may be connected to the second node T4node.

In response to a high voltage being applied to the first input terminal R, the input unit 211 may transmit the high voltage to the first node Qnode. Since the transistors Tr4 and Tr4-1 are connected in series to each other, a voltage (hereinafter, “the input unit voltage”) between the first input terminal R and the first node Qnode may be divided between the transistors Tr4 and Tr4-1, and as a result, a leakage current at the second node T4node may be lowered.

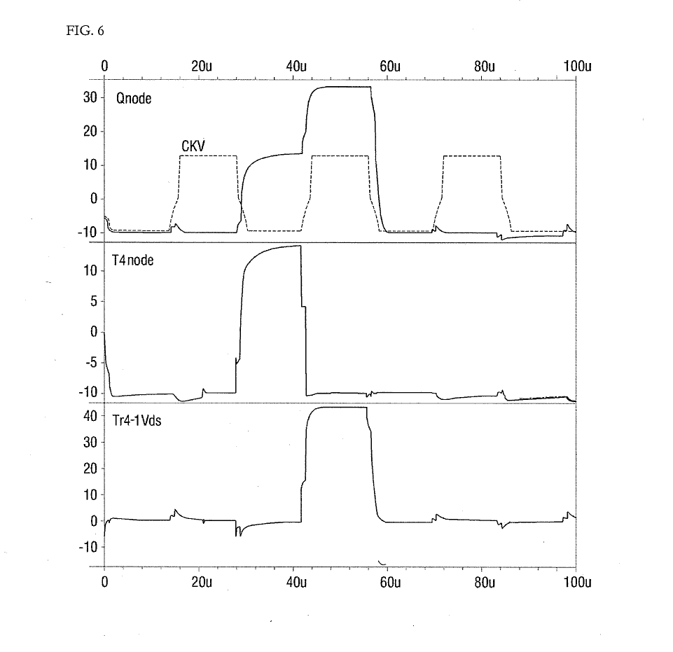

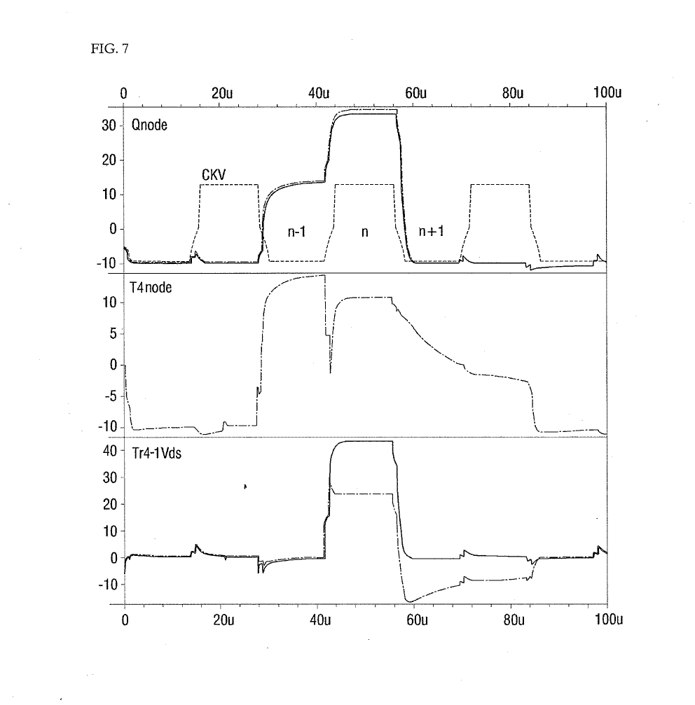

The transistor Tr15-1 may transmit a j-th stage carry signal Cout(j) to the second node T4node. By applying the voltage at the carry signal output terminal OUT2 of the j-th stage STⱼ to the second node T4node, the voltage at the transistor Tr4-1 may be lowered, and as a result, the deterioration of the transistor Tr4-1 may be prevented. A method to prevent the deterioration of the transistor TR4-1 will hereinafter be described with reference to FIGS. 6 and 7.

FIG. 6 illustrates the operating characteristics of a circuit not including the transistor Tr15-1. More specifically, the graph (hereinafter, “the first graph”) at the top of FIG. 6 illustrates the variation of the voltage at the first node Qnode, the graph (hereinafter, “the second graph”) in the middle of FIG. 6 illustrates the variation of the voltage at the second node T4node, and the graph (hereinafter, “the third graph”) at the bottom of FIG. 6 illustrates the variation of a drain-source voltage Vds at the transistor Tr4-1.

Referring to the first graph of FIG. 6, in response to receipt of a previous-stage carry signal, the transistors Tr4 and Tr4-1 may be turned on, and as a result, the voltage of the previous-stage carry signal may be applied to the first node Qnode. Since the output unit 214 includes the output capacitor C, the first node Qnode may store the voltage of the previous-stage carry signal in the output capacitor C. In response to receipt of the clock signal CKV, the voltage of the clock signal CKV may be transmitted to the first node Qnode via the transistor Tr15, and as a result, a boosted-up voltage may be applied to the first node Qnode. In response to receipt of a subsequent-stage carry signal, the transistors Tr9 and Tr9-1 may be turned on, and as a result, the second gate-off voltage VSS2 may be applied to the first node Qnode. Accordingly, the first node Qnode may have a negative voltage level.

Referring to the second graph of FIG. 6, in response to receipt of the previous-stage carry signal, the transistor Tr4 may apply the voltage of the previous-stage carry signal to the second node T4node.

Referring to the third graph of FIG. 7, a voltage obtained by subtracting the voltage at the second node T4node from the voltage at the first node Qnode may be applied to the transistor Tr4-1 as the drain-source voltage Vds.

FIG. 7 illustrates the operating characteristics of a circuit with the transistor Tr15-1. More specifically, the graph (hereinafter, “the first graph”) at the top of FIG. 7 illustrates the variation of the voltage at the first node Qnode, the graph (hereinafter, “the second graph”) in the middle of FIG. 7 illustrates the variation of the voltage at the second node T4node, and the graph (hereinafter, “the third graph”) at the bottom of FIG. 7 illustrates the variation of the drain-source voltage Vds at the transistor Tr4-1.

Referring to the first graph of FIG. 7, in response to receipt of a previous-stage carry signal, the transistors Tr4 and Tr4-1 may be turned on, and as a result, the voltage of the previous-stage carry signal may be applied to the first node Qnode. Since the first node Qnode includes the output capacitor C, the first node Qnode may store the voltage of the previous-stage carry signal therein. In response to receipt of the clock signal CKV, the voltage of the clock signal CKV may be transmitted to the first node Qnode via the transistor Tr15, and as a result, a boosted-up voltage may be applied to the first node Qnode. In response to receipt of a subsequent-stage carry signal, the transistors Tr9 and Tr9-1 may be turned on, and as a result, the second gate-off voltage VSS2 may be applied to the first node Qnode. Accordingly, the first node Qnode may have a negative voltage level.

FIG. 7 is a timing diagram illustrating the operating characteristics of the gate driver illustrated in FIG. 3. Referring to the second graph of FIG. 7, in response to receipt of the previous-stage carry signal, the transistor Tr4 may apply the voltage of the previous-stage carry signal to the second node T4node, and may then apply a voltage corresponding to a current-stage carry signal to the second node T4node. Accordingly, the voltage at the second node T4node may be uniformly maintained. A dotted line represents the variation of the voltage at the second node T4node in a case when the transistor Tr15-1 is additionally provided. During an (n−1)-th period, the voltage at the second node T4node may increase to 10V or higher due to the transistors Tr4 and Tr4-1. During an n-th period, the voltage at the second node T4node may be maintained at 10V or higher due to the voltage of the current-stage carry signal. During an (n+1)-th period, a positive voltage may be applied to the second node T4node due to a parasitic capacitor (not illustrated in FIG. 4) of the transistor Tr15.

Referring to the third graph of FIG. 7, a voltage obtained by subtracting the voltage at the second node T4node from the voltage at the first node Qnode may be applied to the transistor Tr4-1 as the drain-source voltage Vds. Since the drain-source voltage Vds is at least 10V lower than that before the addition of the transistor Tr15-1, the deterioration of the transistor Tr4-1 that may be caused by a high drain-source voltage Vds can be prevented.

Referring back to FIG. 4, the inverter unit 212 includes a transistor Tr12, a transistor Tr7, a transistor Tr8 and a transistor Tr13. One terminal of the transistor Tr12, i.e., the input terminal of the transistor Tr12, which is diode-connected to the control terminal of the transistor Tr12, is connected to the clock terminal CK, and another terminal of the transistor Tr12, i.e., the output terminal of the transistor Tr12, is connected to the control terminal of the transistor Tr7 and the input terminal of the transistor Tr13. The control terminal of the transistor Tr7 is connected to the output terminal of the transistor Tr12, the input terminal of the transistor Tr7 is connected to the clock terminal CK, and the output terminal of the transistor Tr7 is connected to the third node Inode. The control terminal of the transistor Tr8 is connected to the carry signal output terminal OUT2, the input terminal of the transistor Tr8 is connected to the third node Inode, and the output terminal of the transistor Tr8 is connected to a second power terminal GV2. The input terminal of the transistor Tr13 is connected to the output terminal of the transistor Tr12, the control terminal of the transistor Tr13 is connected to the carry signal output terminal OUT2, and the output terminal of the transistor Tr13 is connected to the second power terminal GV2. In response to a high-level signal being applied as the clock signal CKV, the high-level clock signal CKV may be transmitted to the input terminals of the transistors Tr8 and the transistor Tr13 by the transistor Tr12 and the transistor Tr7, and accordingly, the third node Inode may have a high voltage level. The high-level clock signal CKV may lower the voltage at the third node Inode to the level of the second gate-off voltage VSS2 in response to a carry signal being output from the carry signal output terminal OUT2. As a result, the third node Inode of the inverter unit 212 may have an opposite voltage level to that of the j-th stage carry signal Cout(j) and the gate-on voltage Von.

The carry signal generation unit 213 includes the transistor Tr15. The input terminal of the transistor Tr15 is connected to the clock terminal CK, and may thus receive the clock signal CKV or the inverted clock signal CKVB. The control terminal of the transistor Tr15 is connected to the output terminal of the input unit 211, i.e., the first node Qnode, and the output terminal of the transistor Tr15 is connected to the carry signal output terminal OUT2. A parasitic capacitor (not illustrated) may be formed between the control terminal and the output terminal of the transistor Tr15. The output terminal of the transistor Tr15 is connected not only to the carry signal output terminal OUT2, but also to the noise removal unit 215 and the pull-down unit 216, and may thus receive the second gate-off voltage VSS2. Accordingly, in response to the j-th stage carry signal Cout(j) being low, the transistor Tr15 may have as low a voltage as the second gate-off voltage VSS2.

The output unit 214 may include the transistor Tr1 and the output capacitor C. The control terminal of the transistor Tr1 may be connected to the first node Qnode, the input terminal of the transistor Tr1 may receive the clock signal CKV or the inverted clock signal CKVB via the clock terminal CK, the output capacitor C may be provided between the control terminal and the output terminal of the transistor Tr1, and the output terminal of the transistor Tr1 may be connected to the gate voltage output terminal OUT1. The output terminal of the transistor Tr1 may also be connected to the noise removal unit 215 and the pull-down unit 216, and may also be connected to the first power terminal GV1 via the noise removal unit 215 and the pull-down unit 216. Accordingly, a gate-off voltage having substantially the same level as the first gate-off voltage VSS1 may be output. The output unit 215 may output a gate voltage according to the voltage at the first node Qnode and the clock signal CKV. Due to the voltage at the first node Qnode, a voltage difference may be generated between the control terminal and the output terminal of the first transistor Tr1, and may be stored in the output capacitor C. Then, in response to a high voltage being applied in accordance with the clock signal CKV, the voltage charged in the output capacitor C may be boosted up, and as a result, a high voltage may be output as the gate-on voltage Von.

The noise removal unit 215, which is controlled by the output of the third node Inode, may include a transistor Tr3, a transistor Tr10, a transistor Tr10-1, a transistor Tr11 and a transistor Tr11-1. The control terminal of the transistor Tr3 is connected to the third node Inode, the input terminal of the transistor Tr3 is connected to the gate voltage output terminal OUT1, and the output terminal is connected to the first power terminal GV1. The transistor Tr3 may change the level of the output of the gate voltage output terminal OUT1 to the level of the first gate-off voltage VSS1 according to the voltage at the third node Inode. The transistors Tr10 and Tr10-1 are a pair of transistors having their input terminals connected to each other, their output terminals connected to each other and their control terminals connected together to the same terminal, and will hereinafter be referred to as a pair of additionally connected transistors. The control terminal of the transistor Tr10 and the control terminal of the transistor Tr10-1 are both connected to the third node Inode. The transistors Tr10 and Tr10-1 may change the voltage at the first node Qnode to the level of the second gate-off voltage VSS2 according to the voltage at the third node Inode. Since a difference between the second gate-off voltage VSS2 and the voltage at the third node Inode may be divided between the additionally connected transistors Tr10 and Tr10-1, and as a result, a leakage current at the first node Qnode may be lowered. In an exemplary embodiment, three or more TFTs is additionally connected to the transistors Tr10 and Tr10-1. In this exemplary embodiment, the input terminals of the three or more TFTs is connected to one another. Furthermore, the output terminals of the three or more TFTs may be connected to one another, and the control terminals of the three or more TFTs may all be connected to the third node Inode. The control terminal of the transistor Tr11 may be connected to the third node Inode, the input terminal of the transistor Tr11 may be connected to the carry signal output terminal OUT2, and the output terminal of the transistor Tr11 may be connected to the second power terminal GV2. That is, the transistor Tr11 may change the voltage at the carry signal output terminal OUT2 to the level of the second gate-off voltage VSS2 according to the voltage at the third node Inode. The control terminal of the transistor Tr11-1 may be connected to the third node Inode of the (j−1)-th stage STⱼ₋₁ via the inverter input terminal Iin, the input terminal of the transistor Tr11-1 may be connected to the gate voltage output terminal OUT1, and the output terminal of the transistor Tr11-1 may be connected to the first power terminal GV1. The transistor Tr11-1 may change the voltage at the gate voltage output terminal OUT1 to the level of the first gate-off voltage VSS1 according to the voltage at the third node Inode of the (j−1)-th stage STⱼ₋₁. The transistor Tr3 may change the voltage at the gate voltage output terminal OUT1 to the level of the first gate-off voltage VSS1 according to the inverter output of the j-th stage STⱼ, and the transistor Tr11-1 may change the voltage at the gate voltage output terminal OUT1 to the level of the first gate-off voltage VSS1 according to the inverter output of the (j−1)-th stage STⱼ₋₁.

The pull-down unit 216, which is controlled by a subsequent-stage carry signal, i.e., the carry signal Cout(j+1), may include a transistor Tr2, a transistor Tr9, a transistor Tr9-1, and a transistor Tr17. The control terminal of the transistor Tr2 may be connected to the first input terminal R, the input terminal of the transistor Tr2 may be connected to the gate voltage output terminal OUT1, and the output terminal of the transistor Tr2 may be connected to the first voltage input terminal Vin1. The transistor Tr2 may change the voltage at the gate voltage output terminal OUT1 to the level of the first gate-off voltage VSS1 according to the carry signal Cout(j+1). The transistors Tr9 and Tr9-1 are a pair of additionally connected transistors having their input terminals connected to each other, their output terminals connected to each other and their control terminals connected together to the same terminal. The control terminals of the transistors Tr9 and Tr9-1 may both be connected to the third node Inode, and the output terminals of the transistors Tr9 and Tr9-1 may both be connected to the first input terminal R. Since a difference between the second gate-off voltage VSS2 and the voltage of the carry signal Cout(j+1) (i.e., a low voltage) may be divided between the additionally connected transistors Tr9 and Tr9-1, and as a result, a leakage current at the first node Qnode may be lowered. In an exemplary embodiment, three or more TFTs are additionally connected to the transistors Tr9 and Tr9-1. In this exemplary embodiment, the input terminals of the three or more TFTs are connected to one another, the output terminals of the three or more TFTs are connected to one another, and the control terminals of the three or more TFTs may all be connected to the first input terminal R. The control terminal of the transistor Tr17 may be connected to the first input terminal R, the input terminal of the transistor Tr17 may be connected to the carry signal output terminal OUT2, and the output terminal of the transistor Tr17 may be connected to the second power terminal GV2.

A gate voltage and a carry signal may have various voltage levels, but the first gate-off voltage VSS1 and the second gate-off voltage VSS2 may have a negative voltage level.

In response to the carry signal generation unit 213 and the output unit 214 being driven by the voltage at the first node Qnode, the j-th stage STj may output a high-voltage carry signal Cout(j) and the gate-on voltage Von. Due to a previous-stage carry signal (i.e., the carry signal Cout(j−1)) and the subsequent-stage carry signal (i.e., the carry signal Cout(j+1)), the voltage of the carry signal Cout(j) may be lowered to the level of the second gate-off voltage VSS2, and the gate-on voltage Von may be lowered to the level of the first gate-off voltage VSS1 and may thus become a gate-off voltage.

The characteristics of the j-th stage STⱼ illustrated in FIG. 4 will hereinafter be described.

The gate-off voltage VSS2 may be applied to the output terminals of the transistor Tr8 and the transistor Tr13 of the inverter unit 212. As a result, the voltage at the third node Inode may become as low as the second gate-off voltage VSS2, thereby affecting the transistors of the noise removal unit 215, which receive the voltage at the third node Inode via the control terminals thereof. In general, since an oxide semiconductor TFT may cause at least ten times higher a leakage current than an a-Si TFT, it is necessary to reduce a leakage current when using an oxide semiconductor TFT.

In the exemplary embodiment of FIG. 4, to reduce current leakage at the first node Qnode, two pairs of additionally connected TFTs having their input terminals connected to each other, their output terminals connected to each other and their control terminals connected to the same terminal, i.e., the transistors Tr9 and Tr9-1 and the transistors Tr10 and Tr10-1, may be used. The two pairs of additionally connected TFTs both lower the voltage at the first node Qnode to the level of the second gate-off voltage VSS2. The transistors Tr9 and Tr9-1 may operate according to the carry signal Cout(j+1), and the transistors Tr10 and Tr10-1 may operate according to the inverter output of the third node Inode. A pair of additionally connected transistors are more effective than a single transistor in terms of the reduction of a leakage current. More specifically, due to a difference between the voltage applied to the control terminal of a transistor and the second gate-off voltage VSS2, a leakage current may be generated even when the transistor is turned off. However, if two transistors are additionally connected, the voltage difference may be divided between the two transistors, and thus, the leakage current may be reduced. Particularly, in response to an oxide semiconductor TFT being used, the leakage current may exponentially increase in accordance with the voltage difference. By reducing the voltage difference to a half, the leakage current may be lowered by more than half. Therefore, according to the exemplary embodiment of FIG. 4, it is possible to lower a leakage current by using the two pairs of additionally connected transistors, i.e., the transistors Tr9 and Tr9-1 and the transistors Tr10 and Tr10-1.

In the exemplary embodiment of FIG. 4, the transistor Tr11-1 may stabilize a gate voltage by controlling the gate voltage not to be floated in a current stage, i.e., the j-th stage STⱼ, with the use of the voltage at the third node Inode (i.e., the inverter output of the j-th stage STⱼ). As a result, the gate voltage may be maintained to be low even when noise is generated in response to the clock signal CKV being inverted.

In the exemplary embodiment of FIG. 4, glitch noise that may be generated at the carry signal output terminal OUT2 due to a delayed clock signal may be minimized or removed based on the carry signal Cout(j+1) by using the transistor Tr17.

In the exemplary embodiment of FIG. 4, a transistor and wiring for stabilizing a current stage, i.e., the j-th stage STⱼ, with a signal from a subsequent stage (for example, the carry signal Cout(j+1)) are not provided in the j-th stage STⱼ. Even though the voltage at the first node Qnode or the third node Inode can be stabilized by using such transistor, the current stage-stabilizing transistor is not provided in the j-th stage ST; according to the exemplary embodiment of FIG. 4. Therefore, according to the exemplary embodiment of FIG. 4, it is possible to simplify the interconnections between stages and reduce the size of stages. As a result, it is possible to reduce the size of a gate driver, which is included in a non-display peripheral region of a display device and thus to realize a display device with a narrow bezel.

In the exemplary embodiment of FIG. 4, the second gate-off voltage VSS2 may be applied to the output terminals of the transistors Tr9 and Tr9-1, and as a result, a delay in the dropping of a gate voltage that may be caused by a delayed voltage drop at the first node Qnode may be reduced. That is, the voltage at the first node Qnode may be sufficiently lowered, thereby quickly lowering the gate voltage. Accordingly, the size of a transistor for pulling down the voltage at the gate voltage output terminal OUT1, such as the transistor Tr2, may be reduced. Therefore, according to the exemplary embodiment of FIG. 4, it is possible to realize a display device with a narrow bezel by reducing the size of transistors included in each stage.

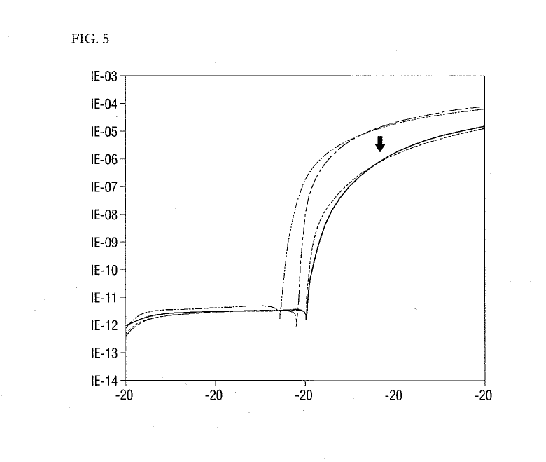

FIG. 5 is a voltage-current graph of a transistor Tr4-1 illustrated in FIG. 4. Referring to FIG. 5, which is a voltage-current graph of the transistor Tr4-1, the horizontal axis represents a voltage difference between the gate electrode and the source electrode of the transistor Tr4-1, and the vertical axis represents a current between the source electrode and the drain electrode of the transistor Tr4-1, i.e., a leakage current.

An oxide semiconductor TFT may or may not deteriorate depending on the levels of a drain-source voltage Vds, which is the voltage applied between the drain electrode and the source electrode of a transistor, and a gate-source voltage Vgs, which is the voltage applied between the gate electrode and the source electrode of a transistor. In response to the previous-stage carry signal, i.e., the carry signal Cout(j−1), being input to the carry signal output terminal OUT2, a drain-source voltage Vds of up to 40V to 50V may be instantly generated at the transistor Tr4-1, thereby deteriorating the transistor Tr4-1. As a result, the voltage of a start signal may be lowered, eventually affecting the gate-on voltage Von. That is, a high drain-source voltage of the transistor Tr4-1 may lower the reliability of the gate driver 200.

In FIG. 5, a chain line and a chain double-dashed line represent the variation of a leakage current for the related art, and a dotted line and a solid line represent the variation of a leakage current for the exemplary embodiment of FIG. 4. That is, according to the exemplary embodiment of FIG. 4, it is possible to lower not only the drain-source voltage Vds, but also the gate-source voltage Vgs, of the transistor Tr4-1 and thus to reduce a leakage current.

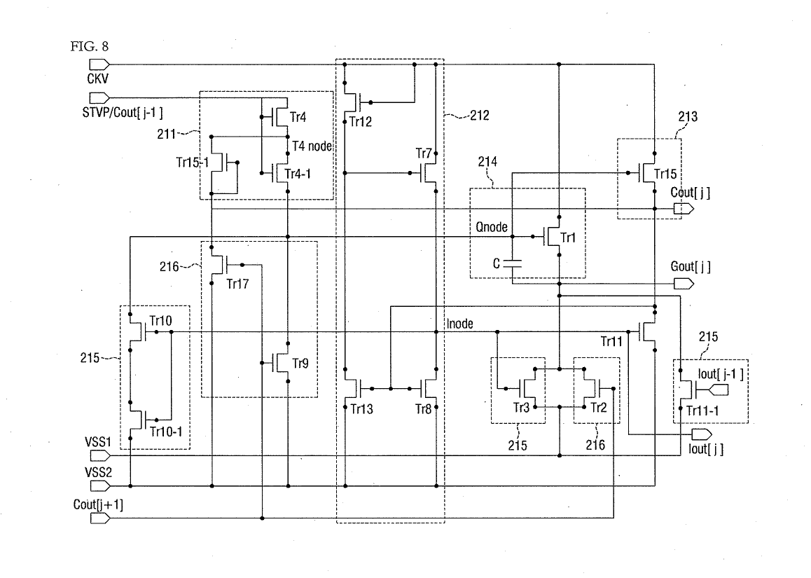

FIGS. 8 to 11 are circuit diagrams of j-th stages of gate drivers according to other exemplary embodiments.

Referring to FIG. 8, the exemplary embodiment of FIG. 8 differs from the exemplary embodiment of FIG. 4 in that the output terminal of a transistor Tr9-1 is connected to a first power terminal GV1.

Accordingly, due to the presence of a pair of additionally connected transistors, i.e., a transistor Tr9 and the transistor Tr9-1, the voltage at a first node Qnode of a current stage may be lowered to the level of a first gate-off voltage VSS1 by a subsequent-stage carry signal.

In the exemplary embodiment of FIG. 8, since the voltage at the first node Qnode cannot become as low as a second gate-off voltage VSS2 due to the transistors Tr9 and Tr9-1, the voltage at the first node Qnode may be able to be quickly lowered, but does not much affect the operation of a gate driver since there are other transistors in a pull-down unit 216. Also, the output of a gate-on voltage may not be affected. Accordingly, the exemplary embodiment of FIG. 8 may be sufficiently beneficial.

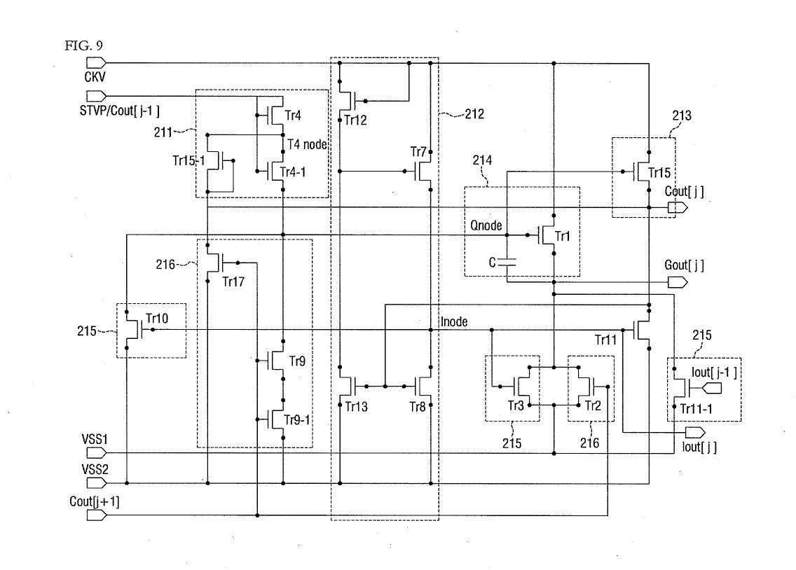

Referring to FIG. 9, the exemplary embodiment of FIG. 9 differs from the exemplary embodiment of FIG. 4 in that a transistor Tr10-1 is not provided.

That is, one of the two pairs of additionally connected transistors of FIG. 4 may be replaced with a single transistor. More specifically, in the exemplary embodiment of FIG. 4, a pair of additionally connected transistors, i.e., the transistors Tr10 and Tr10-1, may be used to reduce a leakage current. However, instead of a pair of additionally connected transistors, a single large TFT may be provided by using the channel width and length of a single transistor.

In the exemplary embodiment of FIG. 9, like in the exemplary embodiment of FIG. 8, the output terminal of a transistor Tr9-1 may be connected to a first power terminal GV1.

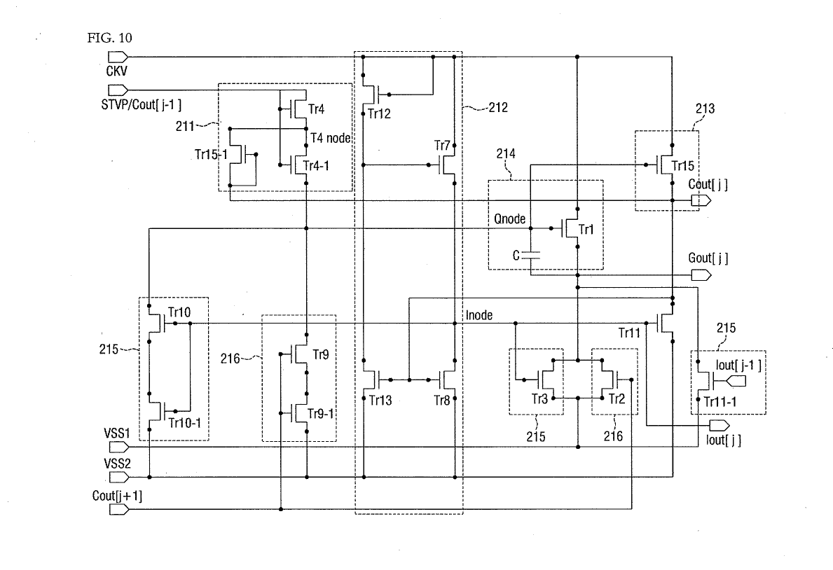

Referring to FIG. 10, the exemplary embodiment of FIG. 10 differs from the exemplary embodiment of FIG. 4 in that a transistor Tr17 is not provided.

In the exemplary embodiment of FIG. 4, the transistor Tr17 may lower a current-stage carry signal, i.e., the carry signal Cout(j), to the level of the second gate-off voltage VSS2 with the use of the subsequent-stage carry signal, i.e., the carry signal Cout(j+1). However, due to the presence of the transistor Tr11, which lowers the level of the carry signal Cout(j) to the level of the second gate-off voltage VSS2 with the use of the inverter output of the j-th stage STⱼ, i.e., the voltage at the third node Inode, the transistor Tr17 may no longer be needed, as illustrated in FIG. 9.

In the exemplary embodiment of FIG. 10, like in the exemplary embodiment of FIG. 8 or 9, the output terminals of transistors Tr9-1 and Tr10-1 may be connected to a first power terminal GV1.

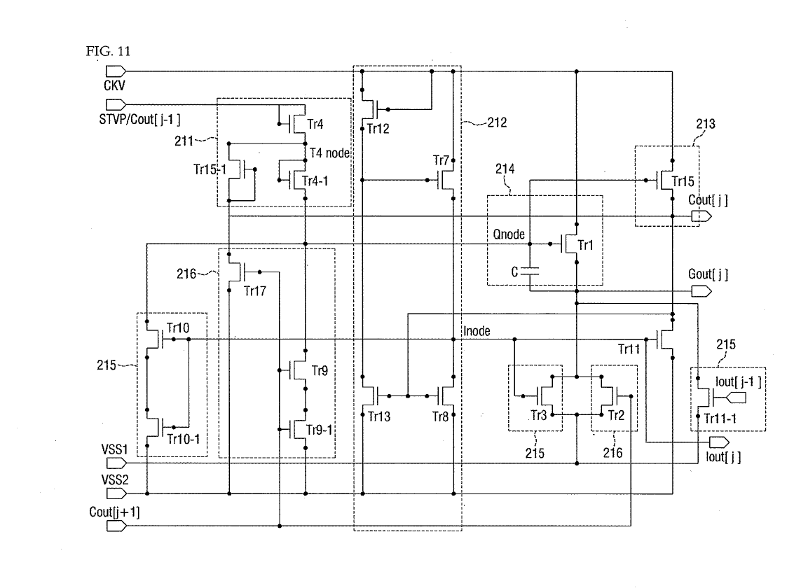

Referring to FIG. 11, the exemplary embodiment of FIG. 11 differs from the exemplary embodiment of FIG. 4 in that the control terminals of transistors Tr4 and Tr4-1 are not connected to a common node.

That is, in the exemplary embodiment of FIG. 11, unlike in the exemplary embodiment of FIG. 4, the control node of the transistor Tr4-1 is connected to a second node T4node. The control terminal of the transistor Tr4 and the input terminal of the transistor Tr4-1 may be connected to each other, i.e., the transistors Tr4 and Tr4-1 may be diode-connected to each other. As a result, the transistor Tr4-1 may be switched on or off by the voltage at the second node T4node. Even if a transistor Tr15-1 is additionally provided, such a voltage may be applied to the second node T4node that the transistor Tr4-1 can operate in its saturated region. As a result, the transistor Tr4-1 may operate substantially in the same manner as its counterpart of the exemplary embodiment of FIG. 4.

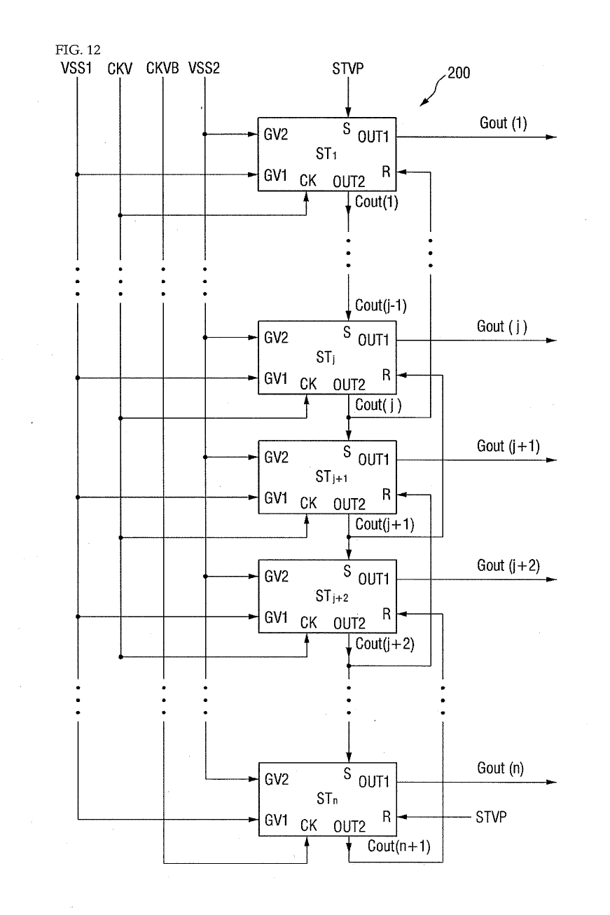

FIG. 12 is a block diagram of a gate driver according to another exemplary embodiment.

Referring to FIG. 12, a gate driver 200 may include first through n-th stages ST₁ through STₙ. Each of the first through n-th stages ST₁ through STₙ may include a first power terminal GV1, a second power terminal GV2, a clock terminal CK, a gate voltage output terminal OUT1, a carry signal output terminal OUT2, a first input terminal R and a second input terminal S.

The second input terminal S of a j-th stage STⱼ (where j≠1), which is connected to a j-th gate line Gj, may receive a carry signal Cout(j−1) from a previous stage, i.e., a (j−1)-th stage ST₍ⱼ₋₁₎. The first input terminal R of the j-th stage STⱼ may receive a carry signal Cout(j+1) from a subsequent stage, i.e., a (j+1)-th stage ST₍ⱼ₊₁₎ and the clock terminal CK of the j-th stage STⱼ may receive a clock signal CKV and an inverted clock signal CKVB. The first power terminal GV1 of the j-th stage STⱼ may receive a first gate-off voltage VSS1 and the second power terminal GV2 of the j-th stage STⱼ may receive a second gate-off voltage VSS2. The gate voltage output terminal OUT1 of the j-th stage STⱼ may output a gate signal Gout(j) and the carry signal output terminal OUT2 of the j-th stage STⱼ may output a carry signal Cout(j).

The first stage ST₁ may receive a start pulse signal STVP, instead of a carry signal from a previous stage thereof, and the n-th stage STₙ, which is the last stage of the gate driver 200, may receive the start pulse signal STVP, instead of a carry signal from a subsequent stage thereof.

The clock terminals CK of the first through n-th stages ST₁ through STₙ may receive the clock signal CKV and the inverted clock signal CKVB, which are generated by a clock generator 400. The gate voltage output terminals OUT1 of the first through n-th stages ST1 through STn may output a high-level portion of the clock signal CKV, which is applied to the clock terminals CK of the first through n-th stages ST1 through STn. The clock signal CKV may be applied to the odd-numbered stages ST, ST3, . . . , and the high-level portion of the clock signal CKV may be output from the gate voltage output terminals OUT1 of the odd-numbered stages ST, ST3, . . . . The clock signal CKV is applied to the even-numbered stages ST2, ST4, . . . , and a high-level portion of the inverted clock signal CKVB is output from the gate voltage output terminals OUT1 of the even-numbered stages ST2, ST4,

Accordingly, the first through n-th stages ST₁ through STₙ may sequentially output first through n-th gate signals Gout(1) through Gout(n), respectively.

Each of the first through n-th gate signals Gout(1) through Gout(n), which are respectively output from the gate voltage output terminals OUT1 of the first through n-th stages ST₁ through STₙ, may be applied to the first through n-th gate lines G1 through Gn, respectively.

The first power terminals GV1 of the first through n-th stages ST₁ through STₙ may be connected to a source of the first gate-off voltage VSS1, and the second power terminals GV2 of the first through n-th stages ST₁ through STₙ may be connected to a source of the second gate-off voltage VSS2.

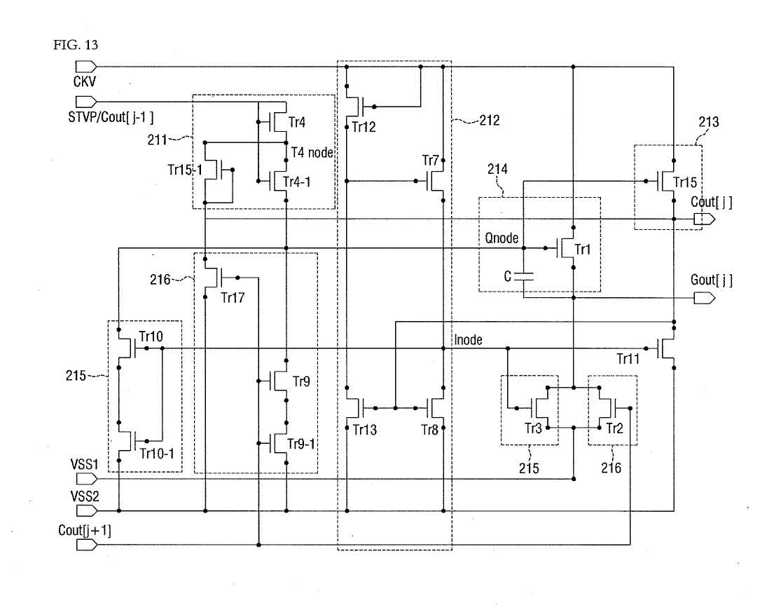

FIG. 13 is a circuit diagram of a j-th stage of the gate driver illustrated in FIG. 12.

Referring to FIG. 13, the exemplary embodiment of FIG. 13 differs from the exemplary embodiment of FIG. 4 in that a transistor Tr11-1 is not provided.

In the exemplary embodiment of FIG. 4, the transistor Tr11-1, which is a transistor for lowering the voltage at the gate voltage output terminal OUT1 to the level of the first gate-off voltage VSS1, lowers a gate voltage based on an inverter output of a previous stage, which is generated by the inverted clock signal CKVB. However, according to the exemplary embodiment of FIG. 12, since there are other transistors for lowering a gate voltage, such as transistors Tr2 and Tr3, the absence of the transistor Tr11-1 does not much affect the operation of the gate driver 200.

In the exemplary embodiment of FIG. 13, like in the exemplary embodiment of FIG. 8 or 9, the output terminals of transistors Tr9-1 and Tr10-1 may be connected to a first power terminal GV1. In the exemplary embodiment of FIG. 13, like in the exemplary embodiment of FIG. 10, a transistor Tr17 may not be provided.

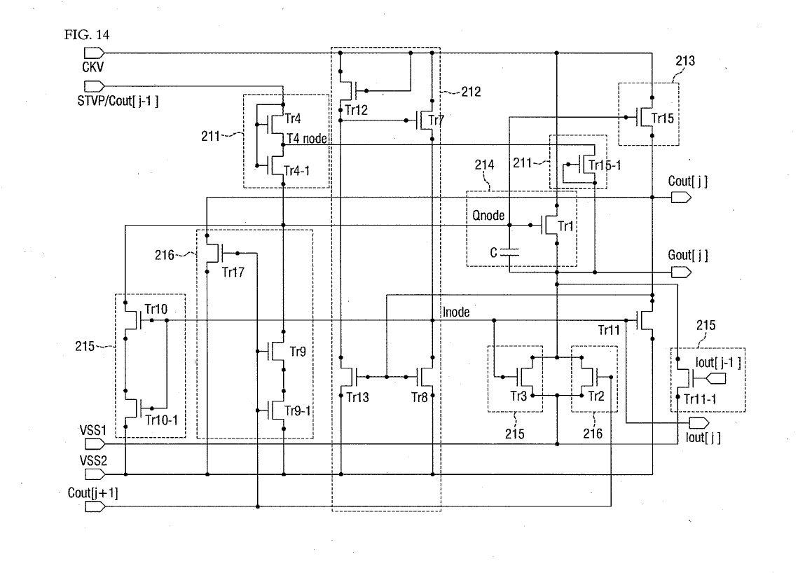

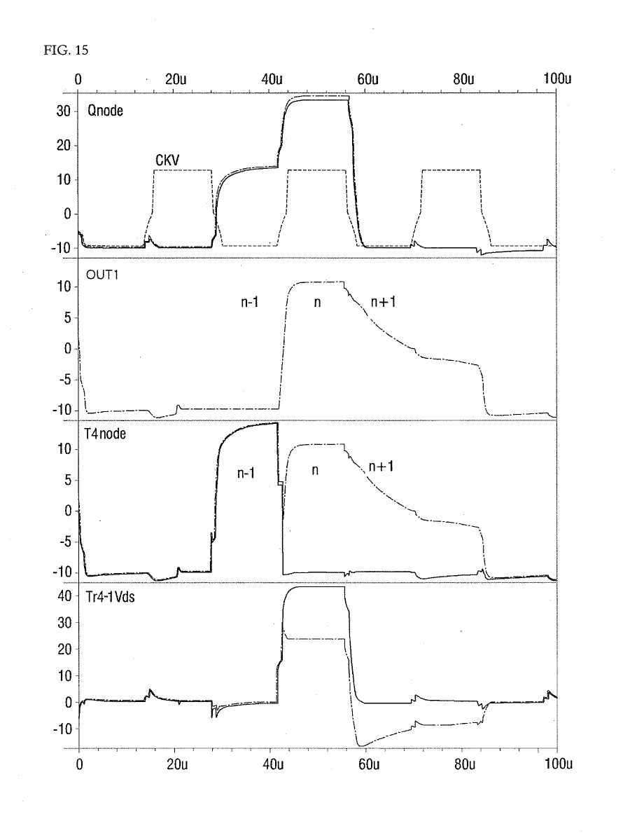

FIG. 14 is a circuit diagram of a j-th stage of a gate driver according to another exemplary embodiment, and FIG. 15 is a timing diagram illustrating the operating characteristics of the gate driver illustrated in FIG. 14.

Referring to FIG. 14, a j-th stage STⱼ of a gate driver 200 may include an input unit 211, an inverter unit 212, a carry signal generation unit 213, an output unit 214, a noise removal unit 215 and a pull-down unit 216.

The input unit 211 may include a transistor Tr4, a transistor Tr4-1, and a transistor Tr15-1. The output terminal of the transistor Tr4 and the input terminal of the transistor Tr4-1 are connected in common to a second node T4node, and the control terminals of the transistor T44 and the transistor Tr4-1 are connected in common to a first input terminal R. The input terminal of the transistor Tr4 is connected to the first input terminal R, and the output terminal of the transistor Tr4-1 is connected to a first node Qnode. The transistor Tr15-1 may be connected to the second node T4node to which the transistors Tr4 and Tr4-1 are connected. The input terminal and the control terminal of the transistor Tr15-1 may be connected in common (i.e., diode-connected) to a gate voltage output terminal OUT1, and the output terminal of the transistor Tr15-1 may be connected to the second node T4node.

In response to a high voltage being applied to the first input terminal R, the input unit 211 may transmit the high voltage to the first node Qnode. Since the transistors Tr4 and Tr4-1 are connected in series, a voltage between the first node Qnode and the carry signal output terminal of a previous stage, i.e., a (j−1)-th stage STⱼ₋₁, may be divided between the transistors Tr4 and Tr4-1, and as a result, a leakage current at the second node T4node may be lowered.

The transistor Tr15-1 may transmit a carry signal Cout(j) of the j-th stage STⱼ to the second node T4node. By applying the voltage at a carry signal output terminal OUT2 of the j-th stage STⱼ to the second node T4node, the voltage at the transistor Tr4-1 may be lowered, and as a result, the deterioration of the transistor Tr4-1 may be prevented. A method to prevent the deterioration of the transistor TR4-1 will hereinafter be described with reference to FIG. 15.

FIG. 15 is a timing diagram illustrating the operating characteristics of a circuit with the transistor Tr15-1 added thereto. More specifically, the first graph at the top of FIG. 15 illustrates the variation of the voltage at the first node Qnode, the second and third graphs in the middle of FIG. 15 illustrate the variation of the voltage at the gate voltage output terminal OUT1 and the variation of the voltage at the second node T4node, respectively, and the fourth graph at the bottom of FIG. 15 illustrates the variation of a drain-source voltage Vds at the transistor Tr4-1.

Referring to the first graph of FIG. 15, in response to receipt of a previous-stage carry signal, the transistors Tr4 and Tr4-1 may be turned on, and as a result, the voltage of the previous-stage carry signal may be applied to the first node Qnode. Since the first node Qnode includes an output capacitor C, the first node Qnode may store the voltage of the previous-stage carry signal therein. In response to receipt of a clock signal CKV, the voltage of the clock signal CKV may be transmitted to the first node Qnode via the transistor Tr15, and as a result, a boosted-up voltage may be applied to the first node Qnode. In response to receipt of a subsequent-stage carry signal, the transistors Tr9 and Tr9-1 may be turned on, and as a result, a second gate-off voltage VSS2 may be applied to the first node Qnode. Accordingly, the first node Qnode may have a negative voltage level.

Referring to the second graph of FIG. 15, which illustrates the variation of a voltage applied to the gate output voltage terminal OUT1 during an n-th section, the voltage at the gate voltage output terminal OUT1 may be a voltage output by a first transistor Tr1 according to the clock signal CKV. Accordingly, the voltage at the gate voltage output terminal OUT1 may be substantially the same as the voltage at the carry signal output terminal OUT2. The voltage at the gate output voltage terminal OUT1 may be maintained through to an (n+1)-th section due to the presence of the output capacitor C.

Referring to the third graph of FIG. 15, in response to receipt of the previous-stage carry signal, the transistor Tr4 may apply the voltage of the previous-stage carry signal to the second node T4node, and may then apply a voltage corresponding to a current-stage carry signal to the second node T4node. Accordingly, the voltage at the second node T4node may be uniformly maintained. A dotted line represents the variation of the voltage at the second node T4node in a case when the transistor Tr15-1 is additionally provided. During an (n−1)-th period, the voltage at the second node T4node may increase to 10V or higher due to the transistors Tr4 and Tr4-1. During an n-th period, the voltage at the second node T4node may be maintained at 10V or higher due to the voltage of the current-stage carry signal. During an (n+1)-th period, a positive voltage may be applied to the second node T4node due to a parasitic capacitor (not illustrated in FIG. 14) of the transistor Tr15.

Referring to the fourth graph of FIG. 15, which illustrates the drain-source voltage Vds at the transistor Tr4-1, a voltage obtained by subtracting the voltage at the second node T4node from the voltage at the first node Qnode may be applied to the transistor Tr4-1 as the drain-source voltage Vds. Since the drain-source voltage Vds is at least 10V lower than that before the addition of the transistor Tr15-1, the deterioration of the transistor Tr4-1 that may be caused by a high drain-source voltage Vds can be prevented.

The inverter unit 212, the carry signal generation unit 213, the output unit 214, the noise removal unit 215 and the pull-down unit 216 are substantially the same as their respective counterparts of FIG. 4, and thus, detailed descriptions thereof will be omitted.

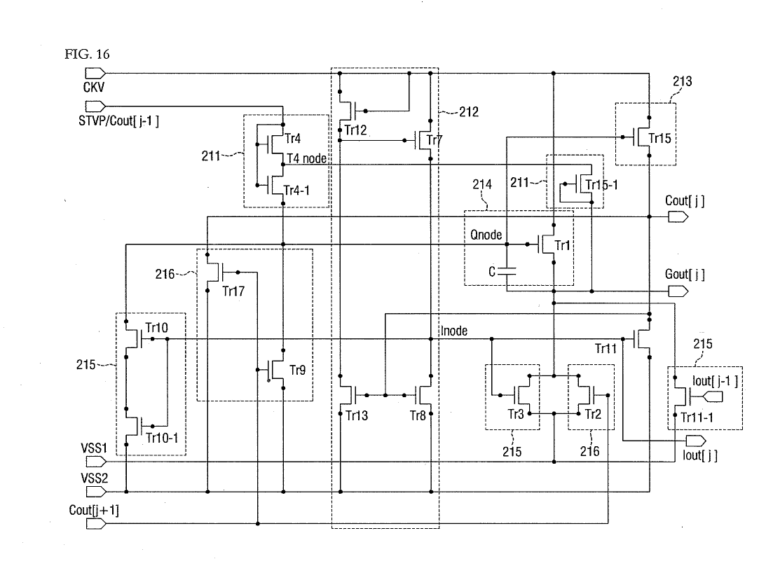

FIGS. 16 to 20 are circuit diagrams of j-th stages of gate drivers according to other exemplary embodiments.

Referring to FIG. 16, the exemplary embodiment of FIG. 16 differs from the exemplary embodiment of FIG. 14 in that the output terminal of a transistor Tr9-1 is connected to a first power terminal GV1.

Accordingly, due to the presence of a pair of additionally connected transistors, i.e., a transistor Tr9 and the transistor Tr9-1, the voltage at a first node Qnode at a current stage may be lowered to the level of a first gate-off voltage VSS1 by a subsequent-stage carry signal.

In the exemplary embodiment of FIG. 16, since the voltage at the first node Qnode cannot become as low as a second gate-off voltage VSS2 due to the transistors Tr9 and Tr9-1, the voltage at the first node Qnode may be able to be quickly lowered, but does not much affect the operation of a gate driver since there are other transistors in a pull-down unit 216. Also, the output of a gate-on voltage may not be affected. Accordingly, the exemplary embodiment of FIG. 16 may be sufficiently beneficial.

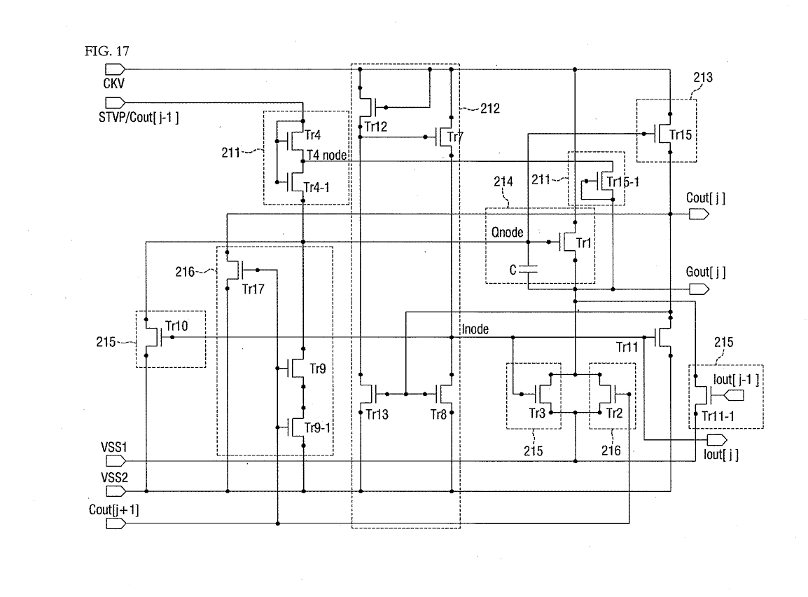

Referring to FIG. 17, the exemplary embodiment of FIG. 17 differs from the exemplary embodiment of FIG. 14 in that a transistor Tr10-1 is not provided.

That is, one of the two pairs of additionally connected transistors of FIG. 14 may be replaced with a single transistor. More specifically, in the exemplary embodiment of FIG. 14, a pair of additionally connected transistors, i.e., the transistors Tr10 and Tr10-1, may be used to reduce a leakage current. However, instead of a pair of additionally connected transistors, a single large TFT may be provided by using the channel width and length of a single transistor.

In the exemplary embodiment of FIG. 17, like in the exemplary embodiment of FIG. 16, the output terminal of a transistor Tr9-1 may be connected to a first power terminal GV1.

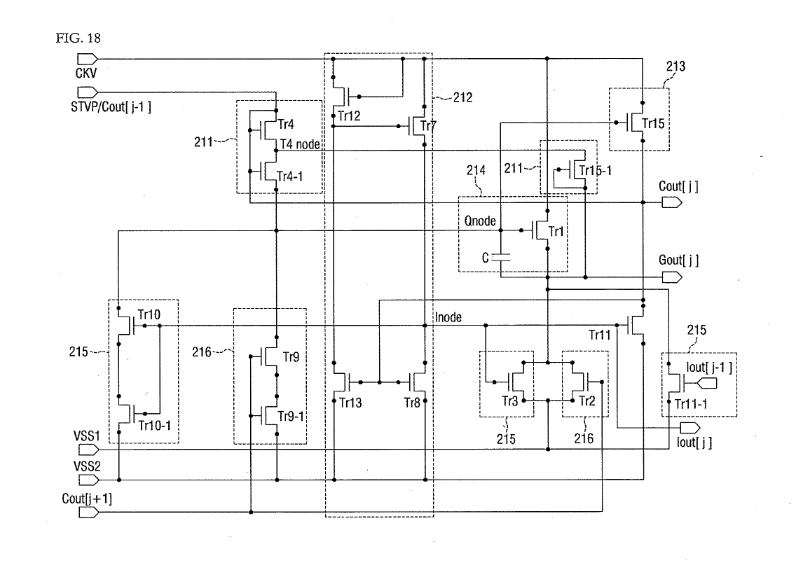

Referring to FIG. 18, the exemplary embodiment of FIG. 18 differs from the exemplary embodiment of FIG. 4 in that a transistor Tr17 is not provided.

In the exemplary embodiment of FIG. 14, the transistor Tr17 may lower a current-stage carry signal, i.e., the carry signal Cout(j), to the level of the second gate-off voltage VSS2 with the use of the subsequent-stage carry signal, i.e., the carry signal Cout(j+1). However, due to the presence of the transistor Tr11, which lowers the level of the carry signal Cout(j) to the level of the second gate-off voltage VSS2 with the use of the inverter output of the j-th stage STⱼ, i.e., the voltage at the third node Inode, the transistor Tr17 may no longer be needed, as illustrated in FIG. 18.

In the exemplary embodiment of FIG. 18, like in the exemplary embodiment of FIG. 16 or 17, the output terminals of transistors Tr9-1 and Tr10-1 may be connected to a first power terminal GV1.

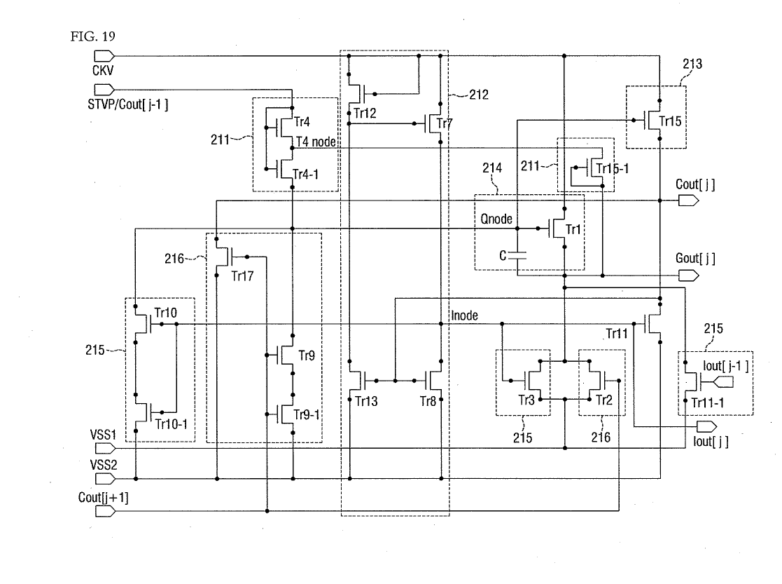

Referring to FIG. 19, the exemplary embodiment of FIG. 19 differs from the exemplary embodiment of FIG. 14 in that the control terminals of transistors Tr4 and Tr4-1 are not connected to a common node.

That is, in the exemplary embodiment of FIG. 19, unlike in the exemplary embodiment of FIG. 14, the control node of the transistor Tr4-1 is connected to a second node T4node. The control terminal of the transistor Tr4 and the input terminal of the transistor Tr4-1 may be connected to each other, i.e., the transistors Tr4 and Tr4-1 may be diode-connected to each other. As a result, the transistor Tr4-1 may be switched on or off by the voltage at the second node T4node. Even if a transistor Tr15-1 is additionally provided, such a voltage may be applied to the second node T4node that the transistor Tr4-1 can operate in its saturated region. As a result, the transistor Tr4-1 may operate substantially in the same manner as its counterpart of the exemplary embodiment of FIG. 14.

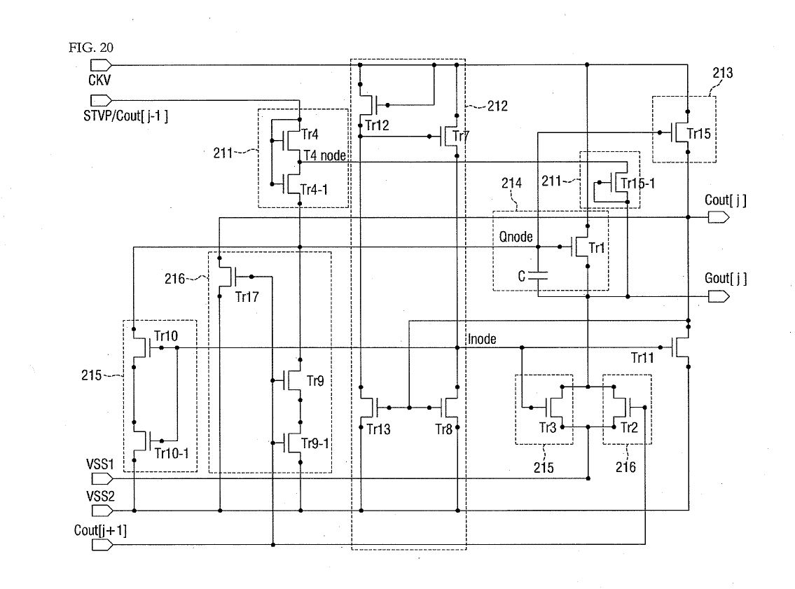

Referring to FIG. 20, the exemplary embodiment of FIG. 20 differs from the exemplary embodiment of FIG. 14 in that a transistor Tr11-1 is not provided.

In the exemplary embodiment of FIG. 14, the transistor Tr11-1, which is a transistor for lowering the voltage at the gate voltage output terminal OUT1 to the level of the first gate-off voltage VSS1, lowers a gate voltage based on an inverter output of a previous stage, which is generated by the inverted clock signal CKVB. However, according to the exemplary embodiment of FIG. 20, since there are other transistors for lowering a gate voltage, such as transistors Tr2 and Tr3, the absence of the transistor Tr11-1 does not much affect the operation of the gate driver 200.

In the exemplary embodiment of FIG. 20, like in the exemplary embodiment of FIG. 16 or 17, the output terminals of transistors Tr9-1 and Tr10-1 may be connected to a first power terminal GV1. In the exemplary embodiment of FIG. 20, like in the exemplary embodiment of FIG. 18, a transistor Tr17 may not be provided.

While the inventive technology has been particularly shown and described with reference to exemplary embodiments thereof, it will be understood by those of ordinary skill in the art that various changes in provide and detail may be made therein without departing from the spirit and scope of the invention as defined by the following claims. The exemplary embodiments should be considered in a descriptive sense only and not for purposes of limitation.

What is claimed is:

1. A gate driver for a display device, comprising:
a plurality of stages connected in cascade,
wherein each of the stages includes:
an input unit configured to connect a first input terminal and a first node, wherein the input unit includes first and second input transistors;
an output unit configured to connect the first node and a first output terminal, wherein the output unit includes an output transistor and an output capacitor; and
a carry signal generator configured to connect a clock terminal and a second output terminal, wherein an output terminal of the first input transistor and an input terminal of the second input terminal are connected to a second node and wherein the input unit further includes a diode-connected transistor configured to apply a carry signal from the first output terminal to the second node.

2. The gate driver of claim 1, wherein the first input terminal is configured to receive a previous-stage carry signal and wherein the first output terminal is configured to output a current-stage carry signal.

3. The gate driver of claim 2, wherein control terminals of the first input transistor and the second input transistor are connected to the first input terminal.

4. The gate driver of claim 3, wherein each of the stages further includes:
an inverter configured to connect the clock terminal and a third node, wherein the inverter includes at least two transistors;
a noise remover configured to connect a first power terminal and the second output terminal, wherein the noise remover includes at least one transistor; and
a pull-down unit configured to apply a voltage at a second power terminal to the first output terminal or the second output terminal according to a signal applied to the second input terminal.

5. The gate driver of claim 4, wherein the clock terminal is configured to receive a clock signal, wherein the second input terminal is configured to receive a subsequent-stage carry signal, wherein the second output terminal is configured to output a current-stage gate signal, wherein the first power terminal is configured to receive a first gate-off signal and wherein the second power terminal is configured to receive a second gate-off signal.

6. The gate driver of claim 4, wherein the noise remover is further configured to connect the second power terminal and the first node and includes at least one transistor.

7. The gate driver of claim 4, wherein the inverter includes a third output terminal connected to the third node and is configured to output an inverter output signal.

8. A gate driver for a display device, comprising:
a plurality of stages connected in cascade,
wherein each of the stages includes:
an input unit configured to connect a first input terminal and a first node, wherein the input unit includes first and second input transistors;
an output unit configured to connect the first node and a second output terminal, wherein the output unit includes an output transistor and an output capacitor; and
a carry signal generator configured to connect a clock terminal and a first output terminal, wherein an output terminal of the first input transistor and an input terminal of the second input terminal are connected to a second node and wherein the input unit further includes a diode-connected transistor configured to apply a carry signal from the second output terminal to the second node.

9. The gate driver of claim 8, wherein the first input terminal is configured to receive a previous-stage carry signal, wherein the first output terminal is configured to receive a current-stage carry signal, and the second input terminal is configured to output a current-stage gate signal.

10. The gate driver of claim 9, wherein control terminals of the first input transistor and the second input transistor are connected to the first input terminal.

11. The gate driver of claim 10, wherein each of the stages further includes:
an inverter configured to connect the clock terminal and a third node, wherein the inverter includes at least two transistors;
a noise remover configured to connect a first power terminal and the second output terminal, wherein the noise remover includes at least one transistor; and
a pull-down unit configured to apply a voltage at a second power terminal to the first output terminal or the second output terminal according to a signal applied to the second input terminal, and
wherein the carry signal generator includes at least one transistor.

12. The gate driver of claim 11, wherein the clock terminal is configured to receive a clock signal, wherein the second input terminal is configured to receive a subsequent-stage carry signal, wherein the first power terminal is configured to receive a first gate-off signal and wherein the second power terminal is configured to receive a second gate-off signal.

13. The gate driver of claim 11, wherein the noise remover is further configured to connect the second power terminal and the first node and includes at least one transistor.

14. The gate driver of claim 11, wherein the inverter includes a third output terminal connected to the third node and is configured to output an inverter output signal.

15. A display device, comprising:
a display panel; and
a gate driver configured to provide a gate signal to the display panel, and comprising a plurality of stages connected in cascade,
wherein each of the stages includes:
an input unit configured to connect a first input terminal and a first node, wherein the input unit includes first and second input transistors;
an output unit configured to connect the first node and a second output terminal, wherein the output unit includes an output transistor and an output capacitor; and
a carry signal generator configured to connect a clock terminal and a first output terminal, wherein an output terminal of the first input transistor and an input terminal of the second input terminal are connected to a second node and wherein the input unit further includes a diode-connected transistor configured to apply a carry signal from the second output terminal to the second node.

16. The display device of claim 15, wherein the first input terminal is configured to receive a previous-stage carry signal, wherein the first output terminal is configured to receive a current-stage carry signal, and wherein control terminals of the first input transistor and the second input transistor are connected to the first input terminal.

17. The display device of claim 16, wherein each of the stages further includes:
an inverter configured to connect the clock terminal and a third node, wherein the inverter includes at least two transistors;
a noise remover configured to connect a first power terminal and the second output terminal, wherein the noise remover includes at least one transistor; and
a pull-down unit configured to apply a voltage at a second power terminal to the first output terminal or the second output terminal according to a signal applied to the second input terminal, and
wherein the carry signal generator includes at least one transistor.

18. The display device of claim 17, wherein the clock terminal is configured to receive a clock signal, wherein the second input terminal is configured to receive a subsequent-stage carry signal, wherein the second output terminal is configured to receive a current-stage gate signal, wherein the first power terminal is configured to receive a first gate-off signal and wherein the second power terminal is configured to receive a second gate-off signal.

19. The display device of claim 17, wherein the noise remover is further configured to connect the second power terminal and the first node and includes at least one transistor.

20. The display device of claim 17, wherein the inverter includes a third output terminal connected to the third node and outputting an inverter output signal.
